(19) United States
(12) Patent Application Publication
(10) Pub. No.: US 2021/0140777 A1
(43) Pub. Date: May 13, 2021

(54) Routing With Environmental Awareness

(71) Applicant: Ford Global Technologies, LLC, Dearborn, MI (US)

(72) Inventor: Alexander Balva, Palo Alto, CA (US)

(21) Appl. No.: 17/048,006

(22) PCT Filed: Apr. 16, 2018
(86) PCT No.: PCT/US2018/027776

§ 371 Date: Oct. 15, 2020

(51) Int. Cl. G01C 21/34; G01C 21/36

(52) U.S. Cl. CPC G01C 21/3461; G01C 21/3691; G01C 21/3492; G01C 21/3484

(57) ABSTRACT

A provider, such as a transportation management service, can evaluate potential routing solutions based on various environmental metrics. Environmental metrics can include various aspect of potential routing solution that might impact routing solution desirability such as weather exposure to a predicted weather event. The evaluation can be based on weights indicating preferences of riders relating to the environmental metrics. These weights can be determined through surveys, reviews, or otherwise analyzing historical data and rider responses.

### BACKGROUND

With the advent and proliferation of navigation applications and services, people are increasingly turning to these applications and services to guide them to their destinations. While traditional street and transit maps can provide anyone the lay of the land, navigation applications help people find the fastest route to their destination. These navigation applications and services are effective at minimizing trip durations and cost but are less useful as a passenger becomes more familiar with the roads and public transit of an area.

### BRIEF DESCRIPTION OF THE DRAWINGS

Various embodiments in accordance with the present disclosure will be described with reference to the drawings, in which:

FIG. 1 illustrates an example ride request environment in which various embodiments can be implemented.

FIGS. 2A and 2B illustrate example origination and destination locations, and routes for serving those locations, that can be determined for a service area over a period of time in accordance with various embodiments.

FIG. 3 illustrates example service metrics that can be balanced via an objective function in accordance with various embodiments.

FIG. 4 illustrates an example system that can be utilized to implement aspects of the various embodiments.

FIG. 5 illustrates an example process for determining a routing solution for a set of trip requests that can be utilized in accordance with various embodiments.

FIG. 6 illustrates an example process for optimizing proposed routing solutions that can be utilized in accordance with various embodiments.

FIGS. 7A, 7B, and 7C illustrate example request and capacity data that can be provided in accordance with various embodiments.

FIGS. 8A, 8B, 8C, and 8D provide approaches for proactively positioning capacity based upon anticipated demand that can be utilized in accordance with various embodiments.

FIG. 9 illustrates an example system that can be utilized to implement predictive aspects of the various embodiments.

FIG. 10 illustrates an example process for proactively positioning capacity that can be utilized in accordance with various embodiments.

FIG. 11 illustrates an example process for determining proactive placement that can be utilized in accordance with various embodiments.

FIG. 12 illustrates an example process for evaluating a potential routing solution.

FIGS. 13A-13B depict changing an example route in an example city map based on environmental metrics in accordance with various embodiments.

FIGS. 14A-14B illustrate and example technique for determining a rider profile in accordance with various embodiments.

FIG. 15 illustrates an example computing device that can be utilized to submit trip requests and receive route options in accordance with various embodiments.

FIG. 16 illustrates example components of a computing device that can be utilized to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches described and suggested herein relate to the evaluating of potential routing solutions requests based on environmental metric of the potential routing solutions. The potential routing solution can be in a response to a trip request. The trip request can relate to the transportation of people, animals, packages, or other objects or passengers, from an origination location to a destination location. The trip request may also include at least one time component. A provider, such as a transportation service, can utilize an objective function to balance various metrics when evaluating potential routing solutions to serve a customer trip request. An objective function can evaluate potential routing solutions based on environmental metrics. Environmental metric can include physical metrics of a route, weather events that are predicted to occur during the route, public events (such as parades or sporting events) that are expected during the route, etc. A process can, using historical data, determine a relationship between an environmental metric and a rider response. The relationship can indicate that a certain environmental metric is preferred by riders or not preferred by riders. An objective function can provide a compromise between, for example, rider experience and provider economics, taking into account metrics such as environmental metrics, rider convenience, operational efficiency, and the ability to deliver on confirmed trips. One or more optimization processes can be applied, which can vary the component values or weightings of the objective function in order to attempt to improve a quality score generated for each proposed routing solution. A process can modify a potential routing solution in order to maximize its quality score. A routing solution can be selected for implementation based at least in part upon the resulting quality scores of the proposed routing solutions.

Various other such functions can be used as well within the scope of the various embodiments as would be apparent to one of ordinary skill in the art in light of the teachings and suggestions contained herein.

FIG. 1 illustrates an example environment 100 in which aspects of the various embodiments can be implemented. In this example, a user can request transportation from an origination to a destination location using, for example, an application executing on a client computing device 110. Various other approaches for submitting requests, such as by messaging or telephonic mechanisms, can be used as well within the scope of the various embodiments. Further, at least some of the requests can be received from, or on behalf of, an object being transported or scheduled to be transported. For example, a client device might be used to submit an initial request for an object, package, or other deliverable, and then subsequent requests might be received from the object, for example, or a device or mechanism associated with the device. Other communications can be used in place of requests, as may relate to instructions, calls, commands, and other data transmissions. For various embodiments discussed herein a “client device” should not narrowly be construed as a conventional computing device unless otherwise stated, and any device or component capable of receiving, transmitting, or processing data and communications can function as a client device in accordance with various embodiments.

The transportation can be provided using a vehicle 100 (or other object) capable of concurrently transporting one or more riders. While riders as used herein will often refer to human passengers, it should be understood that a “rider” in various embodiments can also refer to a non-human rider or passenger, as may include an animal or an inanimate object, such as a package for delivery. In this example, a rideshare service offers routes using at least one type of vehicle that includes space for a driver 102 and seats or other capacity for up to a maximum number of riders. It should be understood that various types of vehicles can be used with different numbers or configurations of capacity, and that autonomous vehicles without dedicated drivers can be utilized as well within the scope of the various embodiments. Vehicles such as smart bicycles or personal transport vehicles may be used as well, which may include seating capacity for only a single rider or limited number of passengers. For a given vehicle on a given route, a number of available seats 106 (or other rider locations) may be occupied by riders, while another number of seats 108 may be unoccupied. In some embodiments objects such as packages or deliveries may also occupy available space for a ride as well. In order to improve the economics of the rides offered, it can be desirable in at least some embodiments to have the occupancy as close to full as possible during the entire length of the trip. Such a situation results in very few unsold seats, which improves operational efficiency. One way to achieve high occupancy might be to offer only fixed routes where all passengers board at a fixed origination location and off-board at a fixed destination location, with no passengers onboarding or off-boarding at intermediate locations.

In the present example, a given user can enter an origination location 112 and a destination location 114, either manually or from a set of suggested locations 116, among other such options, such as by selecting from a map 118 or other interface element. In other embodiments, source such as a machine learning algorithm or artificial intelligence system can select the appropriate locations based on relevant information, such as historical user activity, current location, and the like. Such a system can be trained using historical ride data, and can learn and improve over time using more recent ride and rider data, among other such options. A backend system, or other provider service, can take this information and attempt to match the request with a specific vehicle having capacity at the appropriate time. As known for such purposes, it can be desirable to select a vehicle that will be near the origination location at that time in order to minimize overhead such as fuel and driver costs. As mentioned, the capacity can include a seat for a human rider or sufficient available volume for a package or object to be transported, among other such measures of capacity.

Such an approach may not be optimal for all situations, however, as it may be difficult to get enough users or object providers to agree to be at a specific origination location at a specific time, or within a particular time window, which can lead to relatively low occupancy or capacity utilization, and thus low operational efficiency. Further, such an approach may result in fewer rides being provided, which may reduce overall revenue. Further, requiring multiple users to travel to a specific, fixed origination location may cause those users to utilize other means of transportation, as may involve taxis or dedicated rideshare vehicles that do not require the additional effort. Accordingly, it can be desirable in at least some embodiments to factor rider convenience into the selection of routes to be provided. What may be convenient for one rider, however, may not be convenient for other riders. For example, picking up one rider in front of his or her house might add an additional stop, and additional route distance, to an existing route that might not be acceptable to the riders already on, or assigned to, that route. Further, different riders may prefer to leave at different times from different locations, as well as to get to their destinations within a maximum allowable amount of time, such that the interests of the various riders are at least somewhat competing, against each other and those of the ride provider. Additionally, certain environmental metrics such as an amount of standing required, exposure to bad weather, and pleasant views may enhance or worsen the rider experience. It therefore can be desirable in at least some embodiments to balance the relative experience of the various riders with the economics of the rideshare service for specific rides, routes, or other transportation options. While such an approach will likely prevent a ride provider from maximizing profit per ride, there can be some middle ground that enables the service to be profitable while providing (at a minimum) satisfactory service to the various riders or users of the service. Such an approach can improve the rider experience and result in higher ridership levels, which can increase revenue and profit if managed appropriately.

FIGS. 2A and 2B illustrate one example approach that can be utilized to provide such service in accordance with various embodiments. In the example mapping 200 of FIG. 2A, a set of origination points 202 and destination points 204 indicate locations, over a determined period of time, between which one or more users would like to travel. As illustrated, there are clusters of locations where users may want to be delivered, or objects are to be delivered, as may correspond to town centers, urban locations, or other regions where a number of different businesses or other destinations are located. The origin locations, however, may be less clustered, such as may relate to suburbs or rural areas where rider homes may be located. The clustering can also vary throughout the day, such as where people travel from their homes to their places of employment in the mornings, and generally travel in the reverse directions in the evening. There may be little clustering between these periods, or the clustering may be primarily to locations within an urban area. Economically, it may not be practical for a multi-rider vehicle service to provide each person a dedicated vehicle for the determined route, as the overall occupancy per vehicle would be very low. Ensuring full occupancy for each vehicle, however, can negatively impact the experience of the individual riders who may then have to have longer routes and travel times in order to accommodate the additional riders, which may cause them to select other means of transportation. Similarly, requiring a large number of passengers to meet at the same origination location may be inconvenient for at least some of those passengers, who may then choose alternate travel options.

It thus can be desirable, in at least some embodiments, to provide routes and transportation options that balance, or at least take into consideration, these and other such factors. As an example, the mapping 250 of FIG. 2B illustrates a selection of routes 252 that can be provided over a period of time in order to satisfy various rider requests. The routes may not include or correspond to each precise origination and destination location, but can come within an acceptable distance of those locations in most instances. There may be situations where origination or destination locations are not served, or served at particular times, where route options may not be available, although in some embodiments a dedicated, limited capacity vehicle may be offered at a determined price, among other such options. Further, while the routes may not enable every vehicle to have full occupancy, the number of passengers per vehicle can be sufficient to provide at least adequate profitability or efficiency to the ridesharing service. The routes 252 provided by such a service may change over time, or even at different times of day, but can be sufficiently set such that riders can have at least some level of certainty over their commute or travel. While this may not offer the flexibility of other travel options, it can provide certainty of travel at a potentially lower cost point, which can be desirable to many potential users of the service. As mentioned, however, such a service can also provide added flexibility with other ride options, which may come with a higher price to the potential rider.

In order to determine the routes to provide, as well as the vehicles (or types of vehicles) to use to provide those routes, various factors can be considered as discussed and suggested herein. A function of these factors can then be optimized in order to provide for an improved customer experience, or transport experience for transported objects, while also providing for improved profitability, or at least operational efficiency, with respect to other available routing options. The optimization approaches and route offerings can be updated over time based on other available data, as may relate to more recent ride data, ridership requests, traffic patterns, construction updates, and the like. In some embodiments an artificial intelligence-based approach, as may include machine learning or a trained neural network, for example, can be used to further optimize the function based upon various trends and relationships determined from the data as discussed elsewhere herein.

Approaches in accordance with various embodiments can utilize at least one objective function to determine route options for a set of vehicles, or other transportation mechanisms, for one or more regions of service or coverage. At least one optimization algorithm can be applied to adjust the various factors considered in order to improve a result of the objective function, such as to minimize or maximize the score for a set of route options. The optimization can apply not only to particular routes and vehicles, for example, but also to future planned routes, individual riders or packages, and other such factors. An objective function can serve as an overall measure of quality of a routing solution, set of proposed routing options, or past routing selections. An objective function serves as a codification of a desire to balance various factors of importance, as may include the rider's convenience or experience, as well as the service delivery efficiency for a given area and the quality of service (QoS) compliance for specific trips, among other such options. For a number of given origination and destination locations over a given period of time, the objective function can be applied and each proposed routing solution given a score, such as an optimized route score, which can be used to select the optimal routing solution. In some embodiments the routing option with the highest route score will be selected, while in other embodiments there can be approaches to maximize or minimize the resulting score, or generate a ranking, among various other scoring, ranking, or selection criteria. Routing options with the lowest score may be selected as well in some embodiments, such as where the optimization function may be optimized based on a measure of cost, which may be desirable to be as low as possible, versus a factor such as a measure of benefit, which may be desirable to be as high as possible, among other such options. In other embodiments the option selected may not have the optimal objective score, but has an acceptable objective score while satisfying one or more other ride selection criteria, such as may relate to operational efficiency or minimum rider experience, among others. In one embodiment, an objective function accepts as inputs the rider's convenience, the ability to deliver confirmed trips, the fleet operational efficiency, and the current demand. In some embodiments, there will be weightings of each of these terms that may be learned over time, such as through machine learning. The factors or data making up each of these terms or value can also change or be updated over time.

Component metrics, such as the rider's convenience, environmental metrics, QoS compliance, and service delivery efficiency can serve at least two purposes. For example, the metrics can help to determine key performance indicator (KPI) values useful for, in some embodiments, planning service areas and measuring their operational performance. Performance metrics such as KPIs can help to evaluate the success of various activities, where the relevant KPIs might be selected based upon various goals or targets of the particular organization. Various other types of metrics can be used as well. For instance, locations for which to select service deployment can be considered, such as where a service area (e.g., a city) can be selected, and it may be desired to develop or apply a deployment or selection approach that is determined to be optimal, or at least customized for, the particular service area. Further, these metrics can help to provide real-time optimization goals for the routing system, which can be used to propose or select routes for the various requests. The optimization may require the metrics in some embodiments to be calculated for partial data sets for currently active service windows, which may correspond to a fixed or variable period of time in various embodiments.

As an example, a rider's convenience score can take into account various factors. One factor can be the distance from the rider's requested origination point to the origination point of the selected route. The scoring may be performed using any relevant approach, such as where an exact match is a score of 1.0 and any distance greater than a maximum or specified distance achieves a score of 0.0. The maximum distance may correspond to the maximum distance that a user is willing to walk or travel to an origination location, or the average maximum distance of all users, among other such options. For packages, this may include the distance that a provider is willing to travel to have those packages transported to their respective destinations. The function between these factors can vary as well, such as may utilize a linear or exponential function. For instance, in some embodiments an origination location halfway between the requested and proposed origination locations might be assigned a convenience score of 0.5, while in other approaches is might earn 0.3 or less. A similar approach may be taken for time, where the length of time between the requested and proposed pickups can be inversely proportional to the convenience score applied. Various other factors may be taken into account as well, as may include ride length, number of stops, destination time, anticipated traffic, and other such factors. The convenience value itself may be a weighted combination of these and other such factors.

Optimizing, or at least taking into consideration, a rider's convenience metric can help to ensure that trips offered to the riders are at least competitively convenient. While rider convenience may be subjective, the metric can look at objective metrics to determine whether the convenience is competitive with respect to other means of transportation available. Any appropriate factors can be considered that can be objectively determined or calculated using available data. These factors can include, for example, an ability (or inability) to provide various trip options. The factors can also include a difference in the departure or arrival time with respect to the time(s) requested by the riders for the route. In some embodiments a rider can provide a target time, while in others the riders can provide time windows or acceptable ranges, among other such options. Another factor can relate to the relative trip delay, either as expected or based upon historical data for similar routes. For example certain routes through certain high traffic locations may have variable arrival times, which can be factored into the convenience score for a potential route through that area or those locations. Another factor may relate to the walking (or non-route travel) required of the user for a given route. This can include, as mentioned, the distance between the requested origin and the proposed origin, as well as the distance between the requested destination and the proposed destination. Any walking required to transfer vehicles may also be considered if appropriate.

Various other factors can be considered as well, where the impact on convenience may be difficult to determine but the metrics themselves are relatively straightforward to determine. For example, the currently planned seating or object capacity utilization can be considered. While it can be desirable to have full occupancy or capacity utilization from a provider standpoint, riders might be more comfortable if they have some ability to spread out, or if not every seat in the vehicle is occupied. Similarly, while such an approach may not affect the overall ride length, any backtracking or additional stops at a prior location along the route may be frustrating for various riders, such that these factors may be considered in the rider's convenience, as well as the total number of stops and other such factors. The deviation of a path can also be factored in, as sometimes there may be benefits to taking a specific path around a location for traffic, toll, or other purposes, but this may also be somewhat frustrating to a user in certain circumstances.

Another factor that may be considered with the rider convenience metric, but that may be more difficult to measure, is the desirability of a particular location (or other such environmental metric as discussed herein). In some embodiments the score may be determined by an employee of the provider, while in other embodiments a score may be determined based on reviews or feedback of the various riders, among other such options. Various factors can be considered when evaluating the desirability of a location, as may relate to the type of terrain or traffic associated with a spot. For example, a flat location may get a higher score than a location on a steep hill. Further, the availability, proximity, and type of smart infrastructure can impact the score as well, as locations proximate or managed by smart infrastructure may be scored higher than areas locations without such proximity, as these areas can provide for more efficient and environmentally friendly transport options, among other such advantages. Similarly, a location with little foot traffic might get a higher score than near a busy intersection or street car tracks. In some embodiments a safety metric may be considered, as may be determined based upon data such as crime statistics, visibility, lighting, and customer reviews, among other such options. Various other factors may be considered as well, as may relate to proximity of train lines, retail shops, coffee shops, and the like. In at least some embodiments, a weighted function of these and other factors can be used to determine a rider's convenience score for a proposed route option.

Another component metric that can be utilized in various embodiments relates to the quality of service (QoS) compliance. As mentioned, a QoS compliance or similar metric can be used to ensure that convenience remains uncompromised throughout the delivery of a route. There may be various QoS parameters that apply to a given route, and any deviation from those parameters can negatively impact the quality of service determined for the route. Some factors may be binary in their impact, such as the cancelation of a trip by the system. A trip is either canceled or performed, at least in part, which can indicate compliance with QoS terms. Modification of a route can also impact the QoS compliance score if other aspects of the trip are impacted, such as the arrival time or length of travel. Other factors to be considered are whether the arrival time exceeded the latest committed arrival time, and by how much. Further, factors can relate to whether origination or destination locations were reassigned, as well as whether riders had to wait for an excessive period of time at any of the stops. Reassignment of vehicles, overcapacity, vehicle performance issues, and other factors may also be considered when determining the QoS compliance score. In some embodiments the historical performance of a route based on these factors can be considered when selecting proposed routes as discussed herein.

With respect to service delivery efficiency, the efficiency can be determined for a specific service area (or set of service areas). Such a factor can help to ensure that fleet operations are efficient, at least from a cost or resource standpoint, and can be used to propose or generate different solutions for various principal operational models. The efficiency in some embodiments can be determined based on a combination of vehicle assignment factors, as may related to static and dynamic assignments. For a static vehicle assignment, vehicles can be committed to a service area for the entire duration of a service window, with labor cost being assumed to be fixed. For dynamic vehicle assignment, vehicles can be brought in and out of service as needed. This can provide for higher utilization of vehicles in service, but can result in a variable labor cost. Such an approach can, however, minimize driving distance and time in service, which can reduce fuel and maintenance costs, as well as wear on the vehicles. Such an approach can also potentially increase complexity in managing vehicles, drivers, and other such resources needed to deliver the service.

Various factors can be considered with respect to a service efficiency (or equivalent) metric. These can include, for example, rider miles (or other distance) planned by not yet driven, which can be compared with vehicle miles planned but not yet driven. The comparison can provide a measure of seating density. The vehicle miles can also be compared with a measure of “optimal” rider miles, which can be prorated based upon anticipated capacity and other such values. The comparison between vehicle miles and optimal rider miles can provide a measure of routing efficiency. For example, vehicles not only travel along the passenger routes, but also have to travel to the origination location and from the destination location, as well as potentially to and from a parking location and other such locations as part of the service. The miles traveled by a vehicle in excess of the optimal rider miles can provide a measure of inefficiency. Comparing the optimal rider miles to a metric such as vehicle hours, which are planned but not yet drive, can provide a measure of service efficiency. As opposed to simply distance, the service efficiency metric takes into account driver time (and thus salary, as well as time in traffic and other such factors, which reduce overall efficiency. Thus, in at least some embodiments the efficiency metrics can include factors such as the time needed to prepare for a ride, including getting the vehicle ready (cleaning, placing water bottles or magazines, filling with gas, etc.) as well as driving to the origination location and waiting for the passengers to board. Similarly, the metric can take into account the time needed to finish the ride, such as to drive to a parking location and park the vehicle, clean and check the vehicle, etc. The efficiency can also potentially take into account other maintenance related factors for the vehicle, such as a daily or weekly washing, interior cleaning, maintenance checks, and the like. The vehicle hours can also be compared against the number of riders, which can be prorated to the planned number of riders over a period of time for a specific service area. This comparison can provide a measure of fleet utilization, as the number of available seats for the vehicle hours can be compared against the number of riders to determine occupancy and other such metrics. These and other values can then be combined into an overall service efficiency metric, using weightings and functions for combining these factors, which can be used to score or rank various options provided using other metrics, such as the convenience or QoS metrics.

Certain metrics, such as optimal rider miles and optimal distance, can be problematic to use as a measure of efficiency in some situations. For example, relying on the planned or actual distance of trips as a quantization of the quality of service provided can potentially result in degradation in the rider experience. This can result from the fact that requiring the average rider to travel greater distances may result in better vehicle utilization, but can be less optimal for users that shorter trips. Optimization of distance metrics may then have the negative impact of offsetting any gains in service quality metrics. Accordingly, approaches in accordance with various embodiments can utilize a metric invariant of the behavior of the routing system. In some embodiments, the ideal mileage for a requested trip can be computed. This can assume driving a specific type of vehicle from the origin to the destination without any additional stops or deviations. The “optimal” route can then be determined based at least in part upon the predicted traffic or delays at the requested time of the trip for the ideal route. This can then be advantageously used as a measure of the service that is provided.

An example route determination system can consider trips that are already planned or being planned, as well as trips that are currently in progress. The system can also rely on routes and trips that occurred in the past, for purposes of determining the impact of various options. For trips that are in progress, information such as the remaining duration and distance can be utilized. Using information for planned routes enables the routing system to focus on a part of the service window that can still be impacted, typically going forward in time. For prorated and planned but not yet driven routes, the optimal distance may be difficult to assess directly since the route is not actually being driven. To approximate the optimal distance not yet driven, the routing system can prorate the total optimal distance in some embodiments to represent a portion of the planned distance not yet driven.

FIG. 3 illustrates an example set of service delivery efficiency metrics 300 that can be utilized in accordance with various embodiments. This example shows an approach that can balance planned vehicle miles with planned vehicle hours, and use these to determine “optimal” rider miles 302 for use in determining service efficiency. The optimal miles can be prorated to planned miles that have not yet been driven. The vehicle miles metric 304 can differ from the vehicle hours metric 306 along a number of different dimensions. For example, the vehicle to service area assignment for vehicle miles can be static, while the assignment for vehicle hours can be dynamic. Further, the optimization goal for a vehicle miles-based approach can be routing efficiency, while the optimization goal for a vehicle hours-based approach can be the overall service efficiency. Another type of optimization metric is referred to herein as a “made good” metric. For vehicle miles, this can be an occupancy made good (OMG) metric, and for vehicle hours this can be a velocity made good (VMG) or similar value. These “made good” metrics can provide an indication of whether specific optimization goals are met, and a balance can be made to make sure that both metrics are balanced while satisfying that goal, in order to provide for adequate occupancy (and thus operational efficiency) with sufficient average velocity (to provide operational efficiency as well as customer service satisfaction). Different objective functions can prioritize either parameter (or a combination of the parameters) based on service goals, but can attempt to ensure that the metrics both satisfy specified service criteria.

As mentioned, a route optimization system in some embodiments can attempt to utilize such an objective function in order to determine and compare various routing options. FIG. 4 illustrates an example system 400 that can be utilized to determine and manage vehicle routing in accordance with various embodiments. In this system, various users can use applications executing on various types of computing devices 402 to submit route requests over at least one network 404 to be received by an interface layer 406 of a service provider environment 408. The computing devices can be any appropriate devices known or used for submitting electronic requests, as may include desktop computers, notebook computers, smartphones, tablet computers, and wearable computers, among other such options. The network(s) can include any appropriate network for transmitting the request, as may include any selection or combination of public and private networks using wired or wireless connections, such as the Internet, a cellular data connection, a WiFi connection, a local area network connection (LAN), and the like. The service provider environment can include any resources known or used for receiving and processing electronic requests, as may include various computer servers, data servers, and network infrastructure as discussed elsewhere herein. The interface layer can include interfaces (such as application programming interfaces), routers, load balancers, and other components useful for receiving and routing requests or other communications received to the service provider environment. The interfaces, and content to be displayed through those interfaces, can be provided using one or more content servers capable of serving content (such as web pages or map tiles) stored in a content repository 412 or other such location.

Information for the request can be directed to a route manager 414, such as may include code executing on one or more computing resources, configured to manage aspects of routes to be provided using various vehicles of a vehicle pool or fleet associated with the transport service. The route manager can analyze information for the request, determine available planned routes from a route data store 416 that have capacity can match the criteria of the request, and can provide one or more options back to the corresponding device 402 for selection by the potential rider. The appropriate routes to suggest can be based upon various factors, such as proximity to the origination and destination locations of the request, availability within a determined time window, and the like. In some embodiments, an application on a client device 402 may instead present the available options from which a user can select, and the request can instead involve obtaining a seat for a specific planned route at a particular planned time.

As mentioned, however, in some embodiments users can either suggest route information or provide information that corresponds to a route that would be desired by the user. This can include, for example, an origination location, a destination location, a desired pickup time, and a desired drop-off time. Other values can be provided as well, as may relate to a maximum duration or trip length, maximum number of stops, allowable deviations, and the like. In some embodiments at least some of these values may have maximum or minimum values, or allowable ranges, specified by one or more route criteria. There can also be various rules or policies in place that dictate how these values are allowed to change with various circumstances or situations, such as for specific types of users or locations. The route manager 414 can receive several such requests, and can attempt to determine the best selection of routes to satisfy the various requests. In this example the route manager can work with a route generation module 418 that can take the inputs from the various requests and provide a set of route options that can satisfy those requests. This can include options with different numbers of vehicles, different vehicle selections or placements, and different options for getting the various customers to their approximate destinations at or near the desired times. It should be understood that in some embodiments customers may also request for specific locations and times where deviation is not permissible, and the route manager may need to either determine an acceptable routing option or deny that request if minimum criteria are not met. In some embodiments an option can be provided for each request, and a pricing manager 422 can determine the cost for a specific request using pricing data and guidelines from a price repository 424, which the user can then accept or reject.

In this example, the route generation module 418 can generate a set of routing options based on the received requests for a specified area over a specified period of time. A route optimization module 420 can perform an optimization process using the provided routing options to determine an appropriate set of routes to provide in response to the various requests. Such an optimization can be performed for each received request, in a dynamic routing system, or for a batch of requests, where users submit requests and then receive routing options at a later time. This may be useful for situations where the vehicle service attempts to have at least a minimum occupancy of vehicles or wants to provide the user with certainty regarding the route, which may require a quorum of riders for each specific planned route in some embodiments. In various embodiments an objective function is applied to each potential route in order to generate a route “quality” score, or other such value. The values of the various options can then be analyzed to determine the routing options to select. In one embodiment, the route optimization module 420 applies the objective function to determine the route quality scores and then can select the set of options that provides the highest overall, or highest average, total quality score. Various other approaches can be used as well as would be understood to one of ordinary skill in the art in light of the teachings and suggestions contained herein.

In at least some embodiments, the objective function can be implemented independent of a particular implementation of an optimization algorithm. Such an approach can enable the function to be used as a comparative metric of different approaches based on specific inputs. Further, such an approach enables various optimization algorithms to be utilized that can apply different optimization approaches to the various routing options to attempt to develop additional routing options and potential solutions, which can help to not only improve efficiency but can also potentially provide additional insight into the various options and their impact or interrelations. In some embodiments an optimization console can be utilized that displays the results of various optimization algorithms, and enables a user to compare the various results and factors in an attempt to determine the solution to implement, which may not necessarily provide the best overall score. For example, there might be minimum values or maximum values of various factors that are acceptable, or a provider might set specific values or targets on various factors, and look at the impact on the overall value and select options based on the outcome. In some embodiments the user can view the results of the objective function as well, before any optimization is applied, in order to view the impact of various factor changes on the overall score. Such an approach also enables a user or provider to test new optimization algorithms before selecting or implementing them, in order to determine the predicted performance and flexibility with respect to existing algorithms.

Further, such an approach enables algorithms to evolve automatically over time, as may be done using random experimentation or based on various heuristics. As these algorithms evolve, the value of the objective function can serve as a measure of fitness or value of a new generation of algorithms. Algorithms can change over time as the service areas and ridership demands change, as well as to improve given the same or similar conditions. Such an approach may also be used to anticipate future changes and their impact on the service, as well as how the various factors will change. This can help to determine the need to add more vehicles, reposition parking locations, etc.

In some embodiments artificial intelligence-inclusive approaches, such as those that utilize machine learning, can be used with the optimization algorithms to further improve the performance over time. For example, the raising and lowering of various factors may result in a change in ridership levels, customer reviews, and the like, as well as actual costs and timing, for example, which can be fed back into a machine learning algorithm to learn the appropriate weightings, values, ranges, or factors to be used with an optimization function. In some embodiments the optimization function itself may be produced by a machine learning process that takes into account the various factors and historical information to generate an appropriate function and evolve that function over time based upon more recent result and feedback data, as the machine learning model is further trained and able to develop and recognize new relationships.

Various pricing methods can be used in accordance with the various embodiments, and in at least some embodiments the pricing can be used as a metric for the optimization. For example, the cost factors in some embodiments can be evaluated in combination with one or more revenue or profitability factors. For example, a first ride option might have a higher cost than a second ride option, but might also be able to recognize higher revenue and generate higher satisfaction. Certain routes for dedicated users with few to no intermediate stops might have a relatively high cost per rider, but those riders might be willing to pay a premium for the service. Similarly, the rider experience values generated may be higher as a result. Thus, the fact that this ride option has a higher cost should not necessarily have it determined to be a lower value option than others with lower cost but also lower revenue. In some embodiments there can be pricing parameters and options that are factored into the objective function and optimization algorithms as well. Various pricing algorithms may exist that determine how much a route option would need to have charged to the individual riders. The pricing can be balanced with consumer satisfaction and willingness to pay those rates, among other such factors. The pricing can also take into various other factors as well, such as tokens, credits, discounts, monthly ride passes, and the like. In some embodiments there might also be different types of riders, such as customer who pay a base rate and customers who pay a premium for a higher level of service. These various factors can be considered in the evaluation and optimization of the various route options.

FIG. 5 illustrates an example process 500 for determining routing for a set of user requests that can be utilized in accordance with various embodiments. It should be understood that, for this and other processes discussed herein, there can be additional, fewer, or alternative steps, performed in similar or alternative steps, or in parallel, within the scope of the various embodiments unless otherwise stated. In this example, various trip requests are received 502 from, or on behalf of, various potential customers of a transportation service. The requests in this example relate to a future period of time, for at least one specified service area or region, in which the transport is to occur for one or more persons, animals, packages, or other objects or passengers. The requests can be submitted through an application executed on a computing device in many embodiments, although other request mechanisms can be used as well. In order to determine how to best serve the requests, this example process first determines 504 available vehicle capacity for serving the requests. This can include, for example, determining which vehicles or transport mechanisms are available to that service area over the specified future period of time, as well as the available seating or other capacity of those vehicles for that period of time. As mentioned, in some embodiments at least some of the seats of the various vehicles may already be committed or allocated to specific routes, riders, packages, or other such options.

Based at least in part upon the various available vehicles and capacity, a set of potential routing solutions can be determined 506. This can include, for example, using one or more route determination algorithms that are configured to analyze the various origination and destination locations, as well as the number of passengers and corresponding time windows for each, and generate a set of routing solutions for serving the various requests. The potential solutions can attempt to allocate vehicles to customers based on, for example, common or proximate origination and destination locations, or locations that can be served by a single route of a specific vehicle. In some embodiments a routing algorithm can potentially analyze all possible combinations for serving the requests with the available vehicles and capacity, and can provide any or all options that meet specific criteria, such as at least a minimum utilization or profitability, or at most a maximum allowable deviation (on average or otherwise) from the parameters of the various customer requests. This can include, for example, values such as a distance between the requested origination location and a suggested pick up point, deviations from a requested time, and the like. In some embodiments all potential solutions can be provided for subsequent analysis.

In this example process, the various potential routing solutions can be analyzed 508 using an objective function that balances various factors, such as provider efficiency and customer satisfaction, or at least takes those factors into consideration as discussed elsewhere herein. Each potential routing solution that is analyzed using the function, or at least that meets specific minimum criteria, can be provided with a routing quality score generated inserting the relevant values for the solution into the objective function. This can include, for example determining a weighted combination of various quality factors as discussed herein. In some embodiments, the solution with the best (e.g., highest or lowest) quality score can be selected for implementation. In this example, however, at least one optimization procedure is performed 510 with respect to at least some of the potential solutions. In some embodiments the process might be performed for all potential solutions, while in others only a subset of the solutions will go through an optimization procedure, where solutions with a quality score outside an acceptable range may not be considered for optimization in order to conserve time and resources. The optimization process can attempt to improve the quality scores of the various solutions. As discussed herein, an optimization process can attempt to adjust various parameters of the solution, such as to adjust pickup times, stops per route, capacity distribution, and the like. As mentioned, multiple optimization procedures may be applied in some embodiments, where the algorithms may look at different factors or adjustable ranges, etc. Different optimization algorithms may also optimize for, or prioritize, different factors, such as different QoS or efficiency components, profitability, rider comfort, and the like.

After the optimization, at least some of the various proposed solutions may have updated quality scores. Some of the proposed solutions may also have been removed from consideration based on, for example, unacceptable quality scores or an inability to adequately serve a sufficient number of the pending requests, among other such factors. A specific routing solution can then be selected 512 from the remaining solutions, where the solution can be selected based at least in part upon the optimized quality scores. For example, if optimizing for factors such as profitability or customer satisfaction rating, it can be desirable to select the option with the highest score. If optimizing for factors such as cost, it might be desirable to select the option with the lowest score. Other options can be utilized as well, such as to select the score closest to a target number (e.g., zero). As mentioned, other factors may be considered as well. For example, a solution might be selected that has close to the best quality score, but has a much better profitability or customer satisfaction value, or satisfies one or more other such goals or criteria. Once the solution is determined, the appropriate capacity can be allocated 514 based upon vehicles and seating, among other potential options, determined to be available for the determined region at, or near, the future period of time. This can include, for example, determining routes and stops, and assigning vehicles with appropriate capacity to specific routes. The assignment of specific types of vehicles for certain routes may also be specified in the routing options, as there may be certain types of vehicles that get better gas mileage in town and some that get better gas mileage on the highway, for example, such that operational costs can be broken down by types of vehicles as well. In some embodiments specific vehicles might also be due to service for a specific mileage target, which can be factored in as well as other factors, such as cost per mile, type of gasoline, fuel, or power utilized, and the like. Information about the selected routing option can then be provided 514 to particular customers, such as those associated with the received requests. The information can indicate to the users various aspects such as the time and location of pickup, the route being taken, the location and approximate time of arrival at the destination, and potentially information about the specific vehicle and driver, among other such options.

FIG. 6 illustrates an example process 600 that can be used to optimize potential routing solutions in accordance with various embodiments. In this example, a set of proposed routing solutions is obtained 602, such as by using a process discussed with respect to FIG. 5. The potential routing solutions can provide different options for serving a set of ride or trip requests for various customers, among other such options. Once the solutions are obtained, the solutions can be analyzed and/or optimized in an attempt to determine a best available solution for the received and/or anticipated requests. In this example, at least a subset of the routing solutions will be selected 604 for analysis. This may include solutions that satisfy minimum criteria, such as being able to serve at least a minimum percentage of the requests, or satisfy a minimum variation from the requested trips, among other such options. For a given solution to be analyzed, various values can be determined, a selection of which are presented in this flowchart. Although shown in series for simplicity of explanation, it should be understood that the determinations can be done in parallel or other orders as well within the scope of the various embodiments.

In this example, at least one rider convenience values is determined 606 for the potential routing solution. As mentioned, a metric such as rider convenience can be used to ensure that trips offered to riders are competitively convenient, or at least in line with convenience offered by competitive services. The types of competitive services can be determined using any appropriate mechanism, and updated as appropriate. Whether or not an offering is competitively convenient can be based upon a number of factors, such as may relate to variations in distance, time, capacity, delays, and the like. In this example, a rider convenience value is calculated based upon a weighted function of a number of different parameters, where the relative weighting can be based at least in part upon the determined impact of each factor. A primary factor in the rider convenience value can be the inability to provide any trip options. For example, an inability to provide a route option that is within a maximum allowable distance of a requested origination or destination location within a determined time window, as well as an ability to provide an option that does not exceed a maximum delay time or number of stops, etc. Another factor can be whether a pickup and delivery time can be provided within a specified range of times for the request, as well as a factor indicating a difference in time from a requested pick up or delivery to an anticipated pickup or delivery, with the difference in time negatively impacting the convenience determination. As mentioned elsewhere herein, other factors can relate to a walking or travel distance between the requested and provided origination locations, as well as for the destination locations. The distance can also be determined with respect to an actual origin or destination of the customer, regardless of their requested locations. Factors can also relate to the planned capacity or seating utilization, the amount of backtracking along the route, the desirability of the origination or destination location, as well as the deviation from the optimal path, among other such options.

The at least one rider convenience value can be an environmental metric as discussed herein. Additionally or alternatively to determining the at least one rider convenience value in step 606, other environmental metrics can be determined and evaluated. For example whether the rider will likely be rained on during the proposed routing solution based on determined weather for a determined outside waiting period and whether the waiting period has rain exposure.

In addition, at least one quality of service (QoS) value can be determined 608 for the routing solution. Such a metric can help to ensure that convenience remains uncompromised, to the extent possible or practical, throughout the delivery of the transportation service. The value can be impacted by various factors, as may relate to the cancelation of all or a portion of a trip, which can have the largest impact on the overall QoS value if a service is unable to be delivered. Other factors can relate to the previously-indicated performance as well, as may relate to a breach in the committed latest arrival time, which can either be based upon the amount of time after the committed arrival or can be a binary in some embodiments based on whether or not the committed time was met. Similar factors can relate to whether the pick-up or drop-off locations were changed or reassigned, whether the passengers had to wait while on the vehicle, whether the vehicle was reassigned, or whether the latest committed pick-up time was missed. In some embodiments, the historical performance of a route can be used to provide the data for this metric, and can also be broken down by vehicle, time of day, driver, type of vehicle, and the like.

Further, at least one service delivery efficiency value can be determined 610 for the proposed routing option. Inclusion of such a metric can help to ensure that fleet operations are efficient as well. As mentioned, in some embodiments this can be determined using at least two different operational models, such as may be based upon static and dynamic vehicle assignment. For static vehicle assignment, vehicles can be committed to a service area for the entire duration of a service period, such that the labor cost is fixed and an attempt can be made to minimize driving distance without regard to the length of time in service. Another model can utilize dynamic vehicle assignment, wherein vehicles can be brought in and out of service as needed, such that the labor cost is variable. Accordingly, an attempt can be made to minimize time in service as well as driving distance. Some approaches use a combination of both methods, whereby there are a number of vehicles with static assignment and other vehicles available for dynamic assignment as needed. Approaches for determining the optimal values to use for various service delivery efficiency calculations are discussed in detail elsewhere herein.

Once the various metric values are determined, the objective function can be applied to analyze 612 the values and generate a quality score for the proposed routing solution. Separate from, or as a part of the calculation, at least one optimization process can be performed 614 with respect to the determined routing option, to attempt to improve the associated quality score. As mentioned, this can involve varying some of the metric values, and their component values, as well as the weightings and other aspects within allowable ranges or variances. If there are more proposed routing solutions to consider, the process can continue. Once the proposed solutions have been evaluated and/or optimized, a routing solution can be selected 618 based at least in part upon that solution having the best quality score. This can include, for example, the highest or lowest score, or another such score as discussed and suggested elsewhere herein. As mentioned, in some embodiments optimization processed might not be performed, or may be performed offline in order to attempt to improve the objective function used for subsequent determinations.

Various embodiments can further improve or optimize such approaches, at least in certain circumstances, by accounting for anticipated demand in various routing determinations. As mentioned, determining routes and matching vehicles can provide optimal solutions for a specific set of rides or trips. It will often be the case, however, that the placement of vehicles after these rides will be less than optimal for the next set of rides to be provided. As an example, FIG. 7A shows a set of origination locations 702 for future ride requests, and the current locations 704 of vehicles having capacity to serve those ride requests. The future ride requests could all relate to a future time period, or a current demand, among other such options. The locations 704 of the various vehicles could be proximate a last destination location, or could be a location where the vehicle was parked after a last trip or destination, among other such options.

FIG. 7B illustrates the same distribution 720 of the ride requests, or future demand, and the vehicle locations, or available capacity, but without the map data for purposes of illustration. As illustrated, the locations 704 of the vehicles are somewhat randomly distributed with respect to the origin locations 702. This can result in some of the vehicles having to travel long distances to get to their assigned origination locations, which can result in extra cost and lower utilization as discussed in more detail elsewhere herein. There is thus some inefficiency in the fact that the distribution of demand does not match the distribution of capacity for this point in time. As illustrated, there can be regions 722 of high demand where there is little to no capacity located, such that all vehicles will have to come from outside this location. This can occur in locations such as town centers at afternoon rush hour, for example, where many people are traveling from a small region to destinations scattered about a large region.

For such situations, however, the efficiency can be improved by anticipating the demand and including the anticipated demand in the routing of the vehicles. This can be improved using at least two different approaches. A first approach involves proactively locating vehicles to locations of anticipated demand. For example, as illustrated in the example distribution 740 of FIG. 7C, the vehicles can be proactively positioned such that the density or distribution of the vehicles over various regions is matched, or similar, to the distribution of the anticipated demand. In this way, the average distance to be traveled, and time to reach the origination location, can be significantly decreased. Further, labor costs can be reduced by, for example, moving the vehicle during a driver shift. If the driver is near the end of his or her shift and the vehicle is to be moved to a specific location, the driver can move the vehicle towards that location towards the end of the shift such that additional cost will not be incurred at the start of the next shift to move the vehicle to the origin. Other factors can be considered as well, however, such as the available parking locations, costs for parking at any of those locations, additional distance or time incurred for driving to those locations, and the like. In this example, the density of demand to capacity in the examined region 722 is much more balanced. Thus, even if the actual demand ends up being slightly off from the anticipated demand, the location of capacity to fill those requests will still be much more conveniently placed.

In order to provide for further optimization, approaches in accordance with various embodiments will consider where vehicles will be located at the end of assigned or planned routes before assigning or proactively positioning those vehicles for upcoming routes. This information can also be considered when analyzing various routing options over a period of time. As an example, FIG. 8A illustrates location data 800 for an example situation wherein ride requests require routes to be taken between two origin locations 802 and two destination locations 804. Using just a proactive positioning approach as discussed previously might result in two available vehicles 806 being positioned proximate the two origin locations 802, such that the vehicles will be able to quickly serve those requests at the appropriate time, and with minimal additional cost and effort. One example solution 820 is illustrated in FIG. 8B, wherein a first vehicle 822 moves proximate a first origin location and follows a route to the relevant destination. A second vehicle 824 performs a similar route for the second destination. In this example, however the locations 826 of origins for two future ride requests is displayed. The routes illustrated in FIG. 8B cause both vehicles to end up a significant distance away from the subsequent origin destinations. If both of those vehicles are then positioned to serve routes for the future requests, each vehicle will end up driving a significant amount of additional time and distance to serve the additional requests. Depending upon the relative timing, this may also end up delaying the start time for the subsequent requests.

Approaches in accordance with various embodiments attempt to consider and/or predict this future demand when assigning current or planned routes, based at least in part upon where vehicles will be positioned at the end of specific routes. As an example, consider the alternate route solution 840 illustrated in FIG. 8C. In this example, a first vehicle 822 is assigned to the two origin locations 826 for future demand that are at a significant distance, so that only that vehicle has to travel the full distance. This vehicle 822 also avoids the additional distance needed to travel to the location of one of the currently planned routes. The second vehicle 824 can then serve both the current requests, time permitting, where the respective destination locations 804 are relatively close together. This also significantly decreases the distance that the second vehicle will have to travel, as it will not have to travel the long distance to the subsequent origin locations 826. Thus, there can be advantages in not only proactively positioning vehicles based on anticipated demand, but also considering the future locations of vehicles completing specific routes when optimizing and selecting various routing solutions. A goal of such an approach can be to optimize costs, efficiency, and other factors over a lengthy period of time, instead of for a specific point in time, or relatively short period of time.

FIG. 8D illustrates one example approach for incorporating future capacity and vehicle locations in density matching that can be utilized in accordance with various embodiments. The distribution 860 corresponds to a service area that is broken up into an array of quantized regions. Any appropriate quantization or region selection approach may be utilized, as may be based upon distance, population, average demand, and the like. In this example, open circles represent origin locations for future rides, closed circles represent destinations ending in that region in a prior period of time, and the x markers correspond to vehicles (or seating capacity) in that region at a time of the future demand. In this example, it can be desirable to anticipate the demand in each region, and attempt to get the available capacity as close as possible to the anticipated demand. Excluding costs and other concerns, an ideal optimization might have the available capacity in each region exactly match the anticipated demand. The available capacity for a region can take into account the number of vehicles anticipated to be in that region anyway due to the prior destinations of those vehicles, for example, and can determine the amount of capacity that can be proactively moved into that region. Such an approach can be used with an optimization algorithm to determine a target capacity for each region, as well as a predicted capacity, and within the optimization process attempt to move vehicles proactively to have the availability for the various regions match the capacity. The optimization can also balance various factors, such as whether to prioritize balance across the regions, or deviations from targets within a region, among other such factors. In some embodiments the probability of demand can also be taken into account. For example, if there is a 50% chance that a person will submit a ride request for a specific location at a point in time, then the demand for that location can be set as 0.5 instead of 1.0. The predicted demand across the region can then be an aggregation or statistical combination of these fractional demands.

In order to determine the anticipated demand for a point in time, approaches in accordance with various embodiments can analyze historical data for requests received, routes served, and other aspects over at least a determined period of time in the past. These values can be decayed, weighted, or otherwise accounted for in such a way that more recent data has more of an impact than data from the distant past, etc. The data can also be analyzed for specific time periods or occurrences, such as days of the week, weekends, seasons, events, rush hours, and the like. For a future period of time, such as 10:00 on a Wednesday in the summer for a specific geographical region with no major events listed, the historical data can be analyzed to predict the demand across that region, as well as other values such as the available capacity, routes in progress, and the like. The historical information in at least some embodiments can also be used to train one or more machine learning models, which can then provide predicted demand for a given time period with a given set of conditions, such as may relate to events occurring at that time and the like.

As an example, the historical data for a service area (i.e., a defined geographical region) can include information about the rides requested, including origin and destination locations, for a specific time period. It can also include information associated with those requests, such as maximum numbers of stopped requested, arrival time windows, and types of vehicles or service requested, among other such request options discussed and suggested herein. It can also include information about the type of rider (human, animal, package, etc.) and the type or amount of capacity needed to accommodate that rider. The historical data can also include data for the actual demand, including which routes were actually assigned and delivered, including the individual trips or segments, as well as timing and other such information. The historical data can also include performance data, such as the timeliness, number of miles incurred, amount of time incurred, types of vehicles utilized, stop deviations, etc. The historical information can also identify any special conditions to be considered, such as accidents, construction, or event traffic, which may have impacted the potential values in order to determine whether to consider those specific values in the prediction. Historical data can also include historical environmental metrics and rider response to the respective routes; for example, historical data can specify that a certain route was crowded and that a passenger gave a negative review of their experience. Historical data can be obtained from any of a number of different sources, such as past data for the particular provider, third party data, user data obtained from cell phones or other mechanisms, etc.

The data can be processed to determine, for example, a predicted amount of demand for each of a set of regions within a service area in some embodiments, or a demand distribution or other such predicted demand mapping in others. This can include information about the predicted location and number of requests, such that an attempt can be made to provide sufficient capacity for each predicted trip. As mentioned, the number of riders can be modified by a likelihood factor, such that if there is a 50% chance of two people submitting requests for a particular area then a demand value of 1.0 (or another statistically determined number) may be used for the capacity demand for that location at that time. In some embodiments this can be based upon an average demand for that location and that period as well, where fractional demand is permissible. For example, an average demand could be calculated at 2.3 people, which could case capacity for 2-3 persons to be proactively moved to (or proximate) that location in at least some embodiments. For packages, an overall capacity size as well as an anticipated individual package size can be utilized, with fractional demand further based in part upon probability of demand. As mentioned, a similar approach can be taken to anticipate the destinations for the predicted demand, which can be used to select routes, assign vehicles, and take other such actions as discussed and suggested herein.

FIG. 9 illustrates an example system 900 similar to that of FIG. 4, but which includes additional component configured to predict demand and provide for proactive vehicle movement in accordance with various embodiments. In this example, the system can include at least one demand simulation sub-system 902, device, or component, which can attempt to predict demand for a specific service area as discussed and suggested herein. The demand simulator can determine simulation parameters, such as the time of day (e.g., a fifteen minute window), a day of the week, a season, and special events or planned occurrences (e.g., construction), which can be used to run the simulation. The simulator 902 can obtain relevant data from a historical demand data repository 904, and can analyze that data using one or more predictive algorithms or processes to predict demand (and potentially other values discussed herein) for that particular time and location. As mentioned, in some embodiments machine learning or a trained model can be used instead, which can accept the time and condition input and provide predicted demand and related values accordingly.

In some embodiments the demand simulator 902 can provide the prediction information to the route generation and/or optimization components 418, 420, which can utilize this information to determine routing of vehicle based at least in part upon the predicted demand. This includes proactively moving vehicles, assigning routes and vehicles based on predicted destinations, and the like. In some embodiments this functionality can be injected into an existing system using a false request generator 906, or other such system or service, which can submit user requests corresponding to the predicted demand. This can cause the system to consider the predicted demand when making routing (and other) decisions because these requests will be treated by the system as actual requests. In this example, the route generation module 418 can generate a set of routing options based on the received and fake requests for a specified area over a specified period of time. The route generation module can also determine how to change the state of the available capacity as measured by the objective function.

In some embodiments, the false request generator 906 or other such sub-system can be configured to then cancel the ride at an appropriate time, such as when a cancelation criterion is satisfied, in order to prevent the system from attempting to deliver on the fake route. There may be various cancelation criteria utilized, such as may relate to a distance from the fake route origin location, an amount of time before the start time for the fake route, a scheduled time, or the receiving of an actual route request, among other such options. The criteria used can depend at least in part upon the type of location or amount of available capacity, and the values or thresholds for those criteria can be learned or updated dynamically over time, such as by using machine learning or other such approaches. The vehicle can be proactively placed, and then when the route is canceled the system can direct the vehicle to an appropriate, nearby location using other vehicle placement logic already utilized by the system. In some embodiments there can also be a mechanism for ensuring that actual ride requests take priority over these fake ride requests used for vehicle positioning and other such purposes. For example, a special code or identifier can be used that can cause the request to be treated as low priority, such that other requests or types of routes can take precedence. In other embodiments, the false request generator 906 or route manager 414 can monitor the actual requests, and if necessary can submit a request to cancel the fake request. Various other options can be utilized as well within the scope of the various embodiments. The routing and placement can also be monitored and updated over time, such as to account for variations in actual demand across the service area. The instructions or information sent from a fleet manager 430 to the various vehicles 434 can in many cases be the same as for actual ride requests, while in other embodiments the information may indicate that the route is for proactive placements, such that the driver can be aware that timing and other issues may not be as critical as for other types of requests.

As mentioned, the projection and analysis can be performed for a variety of different service areas, which can be quite large in size or may take a significant time to traverse due to traffic or other conditions. In some locations there may be a limited number of parking facilities available for the vehicles for a service provider, such that the proactive positioning may be at least somewhat limited to selecting the optimal parking facility based upon the predictions. In some embodiments where the facilities are far (time or distance wise) from the predicted origination location, there can be various other factors or options considered as well. These can include, for example, paid street parking, employee residence parking, continual driving for autonomous vehicles, and other such options. For options such as paid parking that involve an additional cost, that cost can be figured into the optimization and routing process. In some embodiments it may be more cost effective to not proactively position a vehicle, where the proactive positioning would involve additional cost, driver overtime, etc. Various approaches can attempt to determine a preferable end-to-end solution with a better vehicle rest location based at least in part upon the projected demand.

In various embodiments an attempt can also be made to maintain a consistency of capacity density over time. For example, in some embodiments the demand is analyzed for periods of time of specific length, such as for 15 minute intervals. Such an approach can mean that there might be four very different demand densities or distributions within a single hour. While it may be desirable to match demand to capacity density, it may not be cost effective to cause some of the vehicles to move up to four times an hour to achieve density matching. Thus, approaches can look to demand density over a period of time and attempt to place vehicles in such a way that, over an extended period of time, the density of capacity may correspond to the density of demand. For example, there might be high demand downtown near the top of the hour as people get off work, but low demand at other times. It may not be practical to move cars in and out of the area every hour based on this fluctuation in demand. Based on cost, however, it may be beneficial to move some of the vehicles from that area if it is anticipated that there will be little demand for the next 45 minutes, and there may be demand in a nearly region. These and other factors can be considered in the optimization and routing approaches, such that the proactive positioning and density matching does not result in excessive vehicle movement and additional cost. Vehicles in many embodiments will only be proactively placed where the benefit justifies the placement, as may be determined using an objective function or other process or algorithm as discussed herein that can take into account metrics such as operational efficiency. As mentioned, in at least some embodiments there may be minimum distances or benefits required before proactively moving a vehicle as well, as moving a vehicle a couple blocks based on a small fluctuation in predicted demand may not justify the action. Factors such as wear to the vehicle and risk of damage or accidents may also be considered, such that there may need to be at least a minimum amount of benefit predicted before moving any specific vehicle. Every mile that a vehicle drives unoccupied can generate additional cost.

As mentioned, the various destinations and time windows of the predicted demand can be considered as well. For example, a predicted demand on a particular block of nine people does not necessarily mean that a single van with nine available seats should be proactively positioned, as the requested routes may be significantly different and unable to practically be served by a single vehicle. Similarly, it may not be cost effective to proactively position nine different vehicles in that location. Accordingly, the proactive placement and routing can be performed based at least in part upon the predicted number of routes to be required from that location, in addition to the seat density or vehicle density used for proactive placement determinations. Thus, density matching may attempt to place the appropriate seating capacity at a location to match the demand capacity, and provide that seating capacity using an appropriate number and/or type(s) of vehicles predicted to be required for the associated route(s).

Accordingly, some approaches can attempt to reach an optimal state that corresponds to a “zero” state for a service area, where the density of capacity is equal to the density of demand for a specified period of time, the demand including both actual and predicted demand. Other approaches can attempt to reach an optimal state where vehicles are moved proactively to attempt to match capacity and demand density to the extent that such vehicle movement satisfies criteria such as those discussed elsewhere herein with respect to the objective function and other such approaches. When a vehicle is not actively serving a trip or route, for example, that vehicle can be parked at a nearby location, moved to a location of anticipated future demand, or moved to a determined intermediate location, among other such options, where in at least some embodiments the selected option corresponds to the overall selected routing solution. In some embodiments routing options for vehicles currently serving routes can also take into account the predicted demand when assigning future routes or modifying existing routes, etc.

When predicting demand, the demand can be expressed as a set of records, where each record can include any of a number of different fields. These fields can include, for example, day of the week, pick up time window, an origin location or identifier, a destination location or identifier, a number of riders, a probability of occurrence, and an average booking lead time, among other such options. In at least some embodiments it can be assumed that the demand records are independent, and predicted demand that fails to materialize will not be carried forward. Further, in at least some embodiments the actual demand in excess of the predicted demand does not reduce the future predicted demand. The predicted demand injection can be performed at the initiation of a service window, for the entire length of the window. A constrained time horizon may be considered for longer service windows in some embodiments. Retraction can be performed immediately before the lead time of the demand record preceding the time interval for which the record has been declared, among other such options. The predictive demand can also be determined stop to stop, as opposed to point to point, where the points can be any identified geographic location. In some embodiments, movement such as walking or other third party transportation may not be considered for predictive placement.

In some embodiments the objective function can be modified or developed to include various factors relating to predictive demand. These can involve new metrics, or factors that make up the various existing metrics of an objective function. For example, with respect to various rider convenience factors, the sensitivity to a time match can be reduced for proactive placement, as well as the penalty for an inability to provide specific trip options relating to proactive placement. A constant walking time can be assumed for the relative trip delay cancelation, as well as a constant length. With respect to the QoS factors, none of these may apply for a proactive placement trip corresponding to a fake route, except that a penalty for trip calculation may be retained but reduced. The service delivery efficiency factors may still all apply for a proactive placement route. Thus, proactive placements are determined and optimized based much more on operational efficiency metrics than quality of service, since there would be no active riders impacted by the service of the proactive route, unless an occurrence impacts the start of an actual planned route, etc.

FIG. 10 illustrates an example process 1000 for proactively positioning vehicles as part of a transportation service offering that can be utilized in accordance with various embodiments. In this example, actual request data can be obtained 1002 for a future period of time and with respect to a specified service area. The actual request data can be obtained through a set of received trip requests, among other options, as discussed and suggested herein. In addition, historical demand data for that service area can be obtained 1004, where the data includes at least historical data relevant to the type of time period. This can include, for example, a type such as may relate to a specific time of day, day of the week, month of the year, season, event date, and the like. It should be understood that the actual request and historical demand data can be obtained in any specific order or concurrently, and that in some embodiments the historical data may be maintained by a provider over an extended period of time. The historical demand can also include information about the type or rider being transported, such as a human or package, as well as an amount of capacity needed to transport that rider, such as two seats for a two person request or volume data for a package, among other such options. Based at least in part upon the actual and predicted demand, a predicted demand can be determined 1006 for various regions of the service area. This can be for dynamically determined regions based on density or requests, for example, or can be fixed, quantized regions based upon distance or other criteria. In order to proactively position the vehicles in this example, a number of proactive requests can be generated 1008 that can be submitted for processing as actual ride requests. Such an approach can cause the system to perform route selection and optimization based on a combination of actual and proactive requests.

Once submitted, the system can process the requests as discussed elsewhere herein. For example, in order to determine how to best select and position vehicles, a measure of available capacity can be determined. This can include, for example, a number of vehicles, a number of available seats or amount of available capacity, or a number of vehicles with specific capacity, among other such options. Once the available capacity and predicted total demand are determined, an attempt can be made to distribute the capacity to more closely match, or correspond to, the predicted demand. In this example, the predicted locations of the various vehicles prior to the time period being analyzed can be determined. This can include, for example, analyzing currently assigned routes, as well as predicted or anticipated routes in some embodiments, to attempt to determine the likely position of each vehicle prior to the respective time. In some embodiments this can also include determining a time at which the vehicle will be at that position, in order to provide a window of time during which that vehicle might be able to be proactively positioned. This can also help to determine anticipated costs, such as may relate to labor, parking, and mileage, etc.

As discussed elsewhere herein, a set of potential routing solutions can be determined 1010, which include not only providing for the actual demand, but also providing for the anticipated demand and proactively positioning vehicles based at least in part upon that anticipated demand. This can be performed using a route suggestion and/or optimization algorithm as discussed elsewhere herein. At least a subset of the proposed routing solutions can be analyzed 1012 using an objective function, or other such mechanism, to determine a quality score or other such value or measure. As mentioned, the objective function can include values for the various customer and operational efficiency metrics that are based at least in part upon the predicted demand and proactive positioning capability. A routing solution can then be selected 1014 based at least in part upon the respective route quality score as discussed elsewhere herein. The relevant routing data can then be transmitted 1016 to the impacted vehicles in order to cause those vehicles to move to the determined locations at the determined time, which in some cases may correspond to proactive placement. In some embodiments or situations the transmission may occur to a computing device associated with the vehicle or a driver of the vehicle, among other such options. Information about the planned or predicted routes can also be transmitted to devices of potential customers in some embodiments, in order to enable those customers to request specific routes, times, stops, or other such options.

FIG. 11 illustrates an example process 1100 for determining proactive placement of vehicles that can be utilized in accordance with various embodiments. In this example, the predicted demand for a service area is determined 1102 based at least in part upon historical data. As mentioned, the relevant data may relate to a corresponding time period, including time of day, day of the week, or event occurrence, among other such options. In this example, the predicted demand relates at least in part to ride or transport requests anticipated to be received from customers. This can be based upon trained neural networks or prediction models, among other such options. For the various anticipated requests, information can be determined 1104 as may relate to a probability of that request being received, as well as a likely number of riders to be submitted for the request. This information can be used to determine 1106 a seating demand for each of a set of quantized region of the service area, where the seating demand can be fractional based at least in part upon the probability being applied to the seating requests as discussed herein. In addition, an anticipated number of routes needed to satisfy the anticipated seating demand can be determined 1108, as the likely variations in destinations will often be unable to be served using a single vehicle while still satisfying the various criteria for route determination.

In addition to determining anticipated demand, a corresponding analysis can be performed for capacity. In this example, the target capacity for each region can be determined 1110 based at least in part upon the anticipated seating demand, where the target capacity can include a number of seats and/or vehicles, and in at least some embodiments can be desired to correspond as closely as possible to the seating and vehicle demand anticipated. In order to determine capacity to move to a specific region, the capacity already allocated to that region for a specific time period can be determined 1112. This can include, for example, vehicles already allocated to provide a ride for that region, vehicles with destinations in that region, vehicles expected to be parked in that region, and so on. Based at least in part upon the difference between the target capacity and the allocated available capacity, additional capacity to be allocated for the various regions can be determined 1114. Using approaches discussed elsewhere herein, various routing solutions can be proposed, optimized, and/or evaluated with an objective function in order to select 1116 an appropriate routing option, which can involve the proactive placement of vehicles in various regions of the service area, in order to cause the available capacity to more closely match, or correspond to, the anticipated demand. Information for the selected solution can then be sent 1118 to the impacted vehicles, or devices associated with the vehicles or drivers, in order to cause those vehicles to move to the indicated locations at the appropriate times. As discussed, it can be desired to smooth and limit the movement over time, as well as to ensure that various operational efficiency standards are still met by the process.

FIG. 12 illustrates example process 1200 for evaluating a route in accordance with various embodiments. Principles of example process 1200 can apply to step 1012 of FIG. 10. In this example, a trip request is obtained 1202 for a potential customer of a transportation service. In some embodiments, the trip request is generated by demand simulator 902.

A potential routing solution for the trip request can be determined 1202. It should be understood that a potential routing solution can service a single trip request or multiple trip requests. As appropriate, the potential routing solution can be similar to a “travel itinerary,” e.g., specifying that the passenger walk to a stop, transfer between vehicles, etc. As appropriate, the potential routing solution can be similar to a “bus network map” including vehicle routes, stops, and timetables for multiple vehicles. It should be understood that a potential routing solution can be a combination of any of the “itinerary” concept, the “network map” concept, a timetable and stop schedule for an individual vehicle, and other concepts disclosed or implied herein.

An environmental metric for the potential routing solution can be determined 1206. The environmental metric can have a value pertaining to a single characteristic, such as a description of how bumpy a road is, a predicted amount of snowfall, a noise level on a vehicle, etc. In some embodiments, an environmental metric can represent an interaction between multiple other environmental metrics such as if there is predicted snow and a potential routing solution includes a segment outside. Some environmental metrics are Boolean, i.e., they are either active or inactive. Examples of Boolean environmental metrics include whether a stop has a bench, whether a vehicle is wheelchair accessible, and whether the vehicle is a bus. Some environmental metrics can represent a prediction that an environmental characteristic will be manifest; for example, if there is a 0.85% chance that a seat will be available on a certain vehicle. Some environmental metrics can represent a degree of something, such as a temperature in a vehicle, a noise level, or a distance. In some embodiments, environmental metrics are normalized around a mean such that if a route is typical for the relevant environmental metric, the environmental metric can be represented as a zero or null value. The environmental metric can be stored in a database for the vehicle, vehicle type, route, stop, location, etc. In some embodiments, environmental metrics can be calculated and adjusted dynamically using sensors, surveys, prediction engines, etc.

The environmental metric represent environmental conditions that a rider would encounter while travelling using the route of the potential routing solution. The environmental metric can be based on weather conditions, weather exposure, seating conditions, stairs, pollution, noise, etc. The environmental metric can be based on a public event such as a sporting event, a rally, a parade, and a holiday that is due to occur before, during, or after the potential routing solution. Some environmental metrics can make the rider experience less pleasant while other environmental metrics enhance the rider experience.

The environmental metric can be based on weather conditions. The weather conditions can be for the location(s) that the passenger will be and the respective times. For example, the transportation service can predict what the weather conditions for a future time at a certain location of the potential routing solution. Weather conditions can include temperature, sun exposure (such as cloudy or sunny), precipitation (e.g., rain, snow, sleet, or hail), wind, air quality (e.g., pollution), pollen count, etc.

The transportation service can determine a weather exposure based on the weather conditions. Weather exposure can mean how much the weather will have an effect on the passenger (or the passenger's potential routing solution). For example, if the transportation service predicts snowfall at a transfer point and time for the potential routing solution, the transportation service can then evaluate whether that stop has exposure to snow (e.g., is it covered). The transportation service can determine that an underground train has little weather exposure, that walks on stairs have a high degree of weather exposure to snow and ice, that walking has exposure to rain, wind, or extreme temperatures, that driving has weather exposure to ice and snow, etc. In some embodiments, a passenger might want to get to a destination at a specific time and arriving early might require the passenger to wait outside; in such situations, the transportation service can penalize potential routing solutions that arrive too early, especially if arriving early subjects the passenger to weather exposure. In some embodiments, the transportation service can use satellite imagery to determine the exposure for a certain area (e.g., to identify whether a stop is covered or uncovered or how quickly snow removal occurs).

The environmental metric can be based on a security metric. The security metric can be based on issues relating to privacy, personal safety, or safety for the passenger's property. Certain vehicles can provide better privacy having private cabins, tinted windows, individual seats, etc. The transportation service can give better scores to potential routing solutions with discrete vehicles (e.g., those that are not branded a certain way to attract attention). The security metric can be evaluated based on the presence or lack of security personnel, security cameras, locks, other passengers, loiterers, etc. The security metric can be based on the presence of a phone to call for help. Security metrics can be evaluated based on the lighting (e.g., expected sunlight, expected moonlight, or artificial light) as well as general cleanliness of the location. The transportation service can evaluate security metrics based on crime reports for respective locations. For example, a certain train station might be more prone to pick-pockets, a parking lot might have more break-ins, and a bus stop might have harassment issues from local loiterers. The security metric can be evaluated based on the time of day, as certain areas that may seem safe during one time period may seem unsafe during another time period. The security metric can be based on how busy vehicles or areas will be, based on historical or anticipated ridership information from the transportation service.

The environmental metric can be based on available food options. Available food options can include food provided by a mode of transportation (e.g., on a train, plane, or boat), at a station, along a route (e.g., a fast food restaurant along a driving portion), etc. The available food options can include a cost for the food, a type of food (e.g., Italian, Korean, American, BBQ), dietary considerations of the food (e.g., whether food options are Kosher, Halal, vegan, vegetarian, organic, locally sourced, or allergy considerations). Certain food options can have times associated with them, for example, how long it takes to go to the food vender, order, receive the food, and eat the food. The transportation service can determine the expected times based on how busy the food vender is expected to be when the passenger would be there. The transportation service can determine if the passenger has enough time to get food based on how much of a detour getting the food would be and how much time is available (e.g., how long a layover is). In some embodiments, the ride request can include a desire for food along the potential routing solution.

The environmental metric can be based on an accessibility metric for the potential routing solution. The accessibility metric can be based on a number of stairs of the potential routing solution and whether the passenger must ascend or descend the stairs (e.g., “three flights of stairs up and two down”), a slope of a path (which can be especially useful for wheelchair users and those carting wheeled goods), an elevation of a vehicle (e.g., to get into a bus), and a distance of walking. The amount of physical exertion can include an elevation gain or loss for a segment. The transportation service can count the amount of “steps” recorded by a portable electronic device on a passenger during travel to estimate the physical conditions for segments of potential routing solutions. Similarly, the transportation service can, through an application on a passenger's phone and with the passenger's consent, determine how much standing and sitting a passenger does at a waiting location based on the phone's orientation.

The accessibility metric can also include factors relevant to passengers with disabilities. For example, some potential routing solutions may be better suited for the blind (e.g., if they have audible announcements or truncated dome tiles indicating safe areas), the deaf (e.g., if they have visual signage), those with mobility constraints (e.g., if elevators or escalators are available, or expected to be available at the respective time), those with size requirements, those with companion animals, or those with anxiety (e.g., if the potential routing solution excludes driving over bridges, driving on highways, riding in crowded areas, or having confusing transfers). The accessibility metric can be based on language information in relation to the rider (e.g., do the languages spoken or in signage correspond to a language of the rider). The accessibility metric can include whether a potential routing solution is wheelchair or stroller friendly.

The potential routing solution metrics can be based on an amount of physical exertion which can be based on a total amount of exertion (e.g., how many calories the passenger would “burn” during the potential routing solution) or the amount of exertion at any time (e.g., how difficult an individual portion is). The amount of physical exertion can be based on the physical conditions of the potential routing solution and metrics of the passenger. The amount of physical exertion can be based on the passenger's age, fitness level, desire to get a workout, and cargo (e.g., if the passenger is carting luggage or a heavy backpack). The amount of physical exertion can be based on an amount of standing time required of the passenger, such as standing on a bus, a train, or while waiting at a stop. The transportation service can determine the likelihood that the passenger will not be able to find a seat on a vehicle based on ridership data for where the passenger gets on the vehicle. Some potential routing solutions may include a jog or fast walking segment which can influence the amount of physical exertion for the potential routing solution.

Some passengers may wish to get exercise and so might prefer a 15 minute walk to 15 minutes of standing, especially if the potential routing solution with the walking portion gets them to their destination quicker. The transportation service can determine, using the passenger's phone (or other portable electronic device) that the passenger is active or desires to be active (e.g., that the passenger has a goal for a certain number of daily “steps”) and weight potential routing solutions accordingly.

The environmental metric can be based on comfort metrics. For example, the transportation service can determine a quality of heating or air conditioning on a vehicle (e.g., some vehicles might get cold and some underground metro segments may get hot). Comfort metrics can be based on an amount of legroom, headroom (e.g., how high the ceiling is), width of a seat, availability of handrails, odor or noise metrics, etc. Comfort metrics can be based on how clean a vehicle or location is. Comfort metrics can be based on how gentle or bumpy a segment is, which can be determined by recording accelerometer readings of a vehicle for that segment.

Comfort metrics can be based on ridership profiles. While travelling, it is common for people to desire to travel with people that are looking for a similar travel experience. A ridership profile can indicate that passengers keep to themselves for a segment (e.g., for work or study), that passenger are talkative for a segment (e.g., for groups of friends), or that a segment is family-friendly (e.g., no alcohol or adult media are present and energetic kids are not a disturbance). The transportation service can determine ridership profiles for each segment of the trip based on the time of day (e.g., a trip on a subway during commute hours will likely be more business-like while the same trip at night will be more lively).

Comfort metrics can be based on whether a vehicle is likely noisy. Some vehicles are designed with acoustic dampening and thus might be more comfortable for passengers that wish to have a quiet trip. Comfort metrics can indicate that locations where a train is underground or turning are more prone to be noisy. The transportation service can determine that some segments are more likely to have noisy people on them (e.g., children leaving school).

Comfort metrics can be based on seat metrics for vehicles or waiting locations. For example, a seat can recline, have more headroom or legroom, and have a soft cushion. Seat metrics can be based on the likelihood that a passenger will be able to get a seat.

The environmental metric can be based on wireless connectivity. While a passenger travels, the passenger might want network connectivity for a portable electronic device using, for example, 802.11 (Wi-Fi) protocols or cellular networks. Wireless connectivity can indicate a signal strength, available bandwidth, carrier (such as cell phone provider or WiFi network), wireless protocol (e.g., HSPA+, LTE, or 802.11 variant), and reliability. In some embodiments, a vehicle might provide wireless connectivity (e.g., a bus, train, or airplane) but have dead zones while, for example entering a tunnel or ascent/descent (for an airplane), which the transportation service can incorporate into the environmental metrics. In some embodiments, the wireless connectivity comes at a cost (or has a free tier and paid tiers of service) and the transportation service can incorporate the cost of the wireless connectivity while evaluating a potential routing solution.

Historical route data for a plurality of historical routes can be obtained 1208.

The environmental metric can be associated with at least one of the plurality of historical routes 1210. Being associated with a route can mean that the environmental metric is applicable for the route. In some embodiments, the environmental is applicable to all routes, even if it is inactive for some (having a null or zero value).

A rider response to the plurality of historical routes can be determined 1212. After riding a route, a rider can provide a response in various ways. The rider response can include the rider scoring the route (e.g., leaving a 1-5 star ranking). The rider response can include the rider leaving a tip for the driver. The rider response can include the rider embarking on the same or similar route at a future time. Similarly, the rider response can include the rider canceling a future trip on the same or similar route. The rider response can include the rider commenting on the route in a dedicated comment channel or on social media. Such comments can be analyzed to determine a sentiment associated with the route. The rider response can include the rider inviting other people (e.g., friends via SMS or a social network) to join the transportation service or to take a similar route. The rider response can include a survey given to the rider after the route.

In some embodiments, the rider response can be based on the rider reviewing their travel itinerary on their phone (or other personal electronic device). This can be indicative of impatience, confusion, or apprehension. Other interactions with a personal electronic device can be used as rider responses; for example, if a rider is connected to a network provided by the transit service, the transit service can determine that the rider is transmitting a lot of data. This might be indicative that the rider is relaxed. Privacy policies can ensure that rider data is not mishandled or collected without permission.

A relationship between the environmental metric and the rider response can be calculated, resulting in a weight for the environmental metric 1214. The weight for the environmental metric can indicate the impact that the environmental metric has on the ride experience. In some embodiments, a potential routing solution is scored by multiplying environmental metrics by their respective weights and adding the results together. The relationship between the environmental metric and the rider response can be derived from various statistical and analytical frameworks. In some embodiments, joint environmental metrics can be used, e.g., if a routing solution would encounter rain at the pickup location and that the pickup location lacks shelter to the rain. These joint metrics can also be considered a derivative environmental metric and can have a determined relationship with the rider response. In some embodiments, the relationship can be a relationship between one environmental metric and another; for example, a preference of cleanliness over having available food options. This can be especially meaningful when the environmental metrics are alternatives.

Because historical data for individual riders might be too small a sample size to determine relationships between an individual rider and the environmental metrics, riders can be pooled together as populations. The pooled populations can be based on a determined motivation for the rider (such as commuters or those going out to eat), a determined demographic of the rider (such as age or gender), or a sponsor for the rider. Colleagues might have similar environmental metric preferences and so pooling populations based on an employer-sponsor can be beneficial.

Alternative or additional to pooling riders in a population, individual trips taken can constitute a sample group for environmental metric relationship derivation. This can help capture contextual preferences for a rider, where the rider has one set of preferences in one context (e.g., putting a high value on a quiet ride the morning) and another set of preferences in another context (e.g., putting a high value on network connectivity in the evening). Alternatively or additionally to pooling individual trips, derivative environmental metrics can be created to capture similar relationships. For example, an environmental metric can be utilized that pertains to a specific time period and a degree of bumpiness of a route. The derived environmental metric can then be analyzed across a large sample size of trips and those that did not occur during the specific time period will not influence the weighting of the derived environmental metric. It should be understood that a derived environmental metric is considered a type of environmental metric.

A rider might state a preference to a certain environmental characteristic, but manifest a different preference to the characteristic. For example, a rider might state that they strongly prefer shorter trips, but the historical data indicate that the rider's choice of routes are based on the route price and not trip length. Certain environmental metrics might be more susceptible to a mismatch between stated preferences and actual preferences; these can be identified and stated preferences for the environmental metric can be less influential when determining weights.

In some embodiments, weights for environmental metrics can be determined based on historical route information. Alternative or additional to using individual trip data, routes as a whole can be analyzed based on their usage or revenue. For example, historical data can specify a route, various environmental metrics, and ridership data, and by analyzing the historical data, a system might determine that when it rains, a certain route has an increase in ridership while another has a decrease in ridership. Different environmental metric weights can be determined for each route. Environmental metric and route interactions can be considered derivative environmental metrics. This can be especially useful when a specific determination of why a route and an environmental metric interact proves difficult to ascertain. In some embodiments, a potential routing solution can be evaluated based on how an environmental metric might impact demand for transit in an area. For example, bad weather or a public event might result in an increase in demand for transit.

The potential routing solution can be evaluated based on the environmental metric and the weight for the environmental metric 1216. In some embodiments, each potential routing solution is evaluated independently. Alternatively or additionally, a set of potential routing solutions can be evaluated as a group, wherein interactions between potential routing solutions and their respective environmental metrics are accounted. For example, if there is a public event such as a concert ending, many people might be crowding the area, if multiple routes are evaluated independently they might each be given a low score because of potential overcrowding in the respective vehicles; however, if they are evaluated jointly, the combined capacity of the set of routes can alleviate the potential overcrowding. If a potential routing solution is associated with multiple ride requests, it can be evaluated based on a rider profile for each ride request. Because riders might have different preferences (which can be represented as weights extracted from historical data in step 1214), they might score routing solutions differently.

This evaluation can include determining how much value the passenger would assign to each potential routing solution. Each metric can increase or decrease the total value of the respective potential routing solutions. Some factors such as weather conditions and total trip time, deal with probabilities, the transit service can determine an expected value to the passenger of the potential routing solution based on how much the passenger values each possible outcome, weighted by its respective probability. The transportation service, when evaluating potential routing solutions, can determine a confidence level that the evaluation accurately matches how the passenger would value the potential routing solution. Potential routing solutions with less than a determined confidence level can be discarded.

In some embodiments, multiple potential routing solutions are generated and the highest evaluated potential routing solution(s) are selected. Alternatively or additionally, a potential routing solution can be iteratively modified until an optimal routing solution is determined. For example, a minor modification that impacts a single environmental metric, or small number of environmental metrics can be made to a proposed routing solution and, if the resultant evaluation improves, another such modification can be made, otherwise the modification can be undone and an opposite minor modification can be tried (if applicable). For example, a starting time for a proposed routing solution can be adjusted forward or backwards until the evaluation stabilizes, another feature of the proposed routing solution (e.g., location of a stop, size or type of vehicle, etc.) can then be modified. Each feature of a proposed routing solution can be optimized in turn. The process can then repeat optimizing the same features in turn until a stable optimization is achieved or a certain number of iterations have elapsed. In some embodiments, the evaluation can identify environmental metrics that influence the evaluation potential routing solution. These environmental metrics can be associated with certain features of the potential routing solution. For example, a crime environmental metric might be dependent on a time of the potential routing solution. These relevant features can be adjusted (e.g., moving the potential routing solution to an earlier time) so that the respective environmental metric is diminished or removed.

Some environmental metrics such as the weather, are subject to change. As environmental metrics change (or their related confidence scores or probabilities of occurrence change) the evaluation can be performed again. New proposed routing solutions can also be determined. In some embodiments, changes to certain environmental metrics can trigger a reevaluation of a proposed routing solution. The amount of change required to trigger a reevaluation can be specific to each metric. In some embodiments, only changes to determined environmental metrics that were significant to a scoring of a routing solution can trigger a reevaluation. For example, if a proposed routing solution was scored higher than others because it provided better shelter from a predicted thunderstorm, if later predictions determine that the thunderstorm is unlikely, a reevaluation can be triggered of the proposed routing solution and generation of new proposed routing solutions. Similarly, previously omitted potential routing solutions can be reevaluated should an environmental metric that had a significant impact on the proposed routing solution change.

FIGS. 13A-13B depict changing an example route 1302 in an example city map 1300 based on environmental metrics according to various embodiments. The “Clear Weather Route” depicted in FIG. 1 can be a routing solution according to when there is clear weather whereas the “Rainy Weather Route” can be a routing solution for when there is rain. The example route 1302 can be responsive to environmental metrics so as to optimize the rider experience as discussed herein. It should be understood that the rainy weather route can be a modification of route 1302 while a vehicle is traversing the route. For example, if a vehicle is travelling from stop 1304ₐ to 1304ᵢ and is currently at stop 1304_{b} the environmental metrics may change sufficiently to warrant a modification of route 1302 from the clear weather route to rainy weather route. It should be understood that such routing solutions need not be predefined and can be dynamically calculated based on the optimization techniques disclosed herein.

Stops 1302 can be removed or added according to environmental metrics. For example, in FIG. 13A, example route 1302 has various stops (e.g., stops 1304ₐ-1304ᵢ) which can represent a typical configuration for route 1302. However, during inclement weather, certain stops or sections may require adjustment. For example, the stop may have exposure to the environmental conditions such as rain, extreme temperatures, wind, snow, etc. Thus, in the rainy weather route, stops 1304_{c}, 1304_{c}, and 1304_{f} have been removed. These stops can be removed because they, for example, are exposed to the rain and a passenger waiting at those stops would get wet. Those passengers can be encouraged therefore to go to other stops (e.g., 1304_{d} or 1304_{b}) where they can remain dry. In some embodiments, having passengers move to a better stop can be impractical or self-defeating (e.g., if the rider would get just as wet travelling to another stop as they would by waiting). Similarly, stops can be added to decrease the distance that a rider would have to walk in the elements to get to the nearest stop. In some embodiments, the environmental metric for respective walks can be considered such that walking portions that are outside are given a greater weight compared to those that are sheltered. In this way, an uncovered stop may be removed if the riders that would use that stop could get to another, covered, stop without exposure to the elements.

Environmental metrics can determine that certain stops should be added to a route. For example, a rider might have a greater desire to be dropped off closer to their destination. A stop can be added at or closer to their destination. In some embodiments, destination stops can be added without adding pick-up stops. Because the schedule of the route might vary due to weather or traffic, an added stop that is closer to a rider's pick-up location might expose them to more bad weather by waiting in the elements than if they had walked to a stop that provided shelter. Thus, adding stops for pick-ups might be less optimal than adding stops for drop-offs.

Environmental metrics may indicate that a route should be adapted by taking a different path. In FIG. 13A, route 1302 goes through stop 1304_{f} whereas in FIG. 13B, route 1302 goes through 1304ₓ. This could be because the rainy weather typically causes traffic congestion near stop 1304_{f}, that the region near 1304_{f} is hazardous during rain (e.g., if there is standing water), or if there is a decrease in demand to go through 1304_{f}. The change can be because stop 1304ₓ provides better shelter against the weather compared to 1304_{f}.

FIGS. 14A-14B illustrate and example technique for determining a rider profile according to various embodiments. As depicted in FIG. 14A, a rider can complete a form to reveal the rider's preferences. A rider might not conscientiously be aware of how much they value each environmental metric and thus might have a difficult time assigning weights to each environmental metric. A form can be presented to the rider so that the rider can identify which they prefer. For example, example form 1400 presents the rider with 5 route options with respective costs, travel times, and relevant environmental metrics. The rider can then rank the routes. When enough routes have been ranked, a system can then determine a rider profile based on the different characteristics of routes and how they were ranked. For example, the route ranked “2” and the route ranked “3” are similar except that “3” includes going up stairs and costs $0.50 less than “2” which includes going down stairs. Therefore, the rider profile can indicate that the rider values going down stairs over going up stairs at least $0.50. Similarly, the rider profile can indicate that the rider values a quiet environment and/or wireless connectivity over good seating because the route ranked “3” is preferred to the route ranked “4.” The route ranked “1” is preferred despite having securities concerns, exposure to rain, a walk downstairs, and a significant price. This can indicate that the rider prefers a shorter trip (5:00 instead of 20:00) above other considerations.

Although example form 1400 involves having the rider rank different real or hypothetical routes, other techniques for having the rider indicate their preferences are contemplated. For examples, the rider can input a monetary value for each environmental metric or route characteristic such as indicating that the rider will be willing to pay a certain amount for wireless connectivity. In some embodiments, a rider can indicate their preferences by selecting and riding a proposed route. The other proposed routes can be inferior to the selected route for the rider. Other ways of indicating rider preferences can include whether the rider “shares” the route to a friend, is a repeat customer of the route, selects other routes in the future, etc.

One rider preferences are exhibited, whether through a form or through less direct means, a system can analyze the data to determine a rider profile and specific weights of various preferences. In other words, the system can determine which environmental metrics are more important to a specific rider or groups of riders.

FIG. 14B illustrates an example rider profile 1450 according to various embodiments. After a system determines a rider profile, the system can represent the profile to the rider. In example rider profile 1450, it is determined that a route's travel time is more important than price and that the rider has a medium preference towards connectivity, comfort, weather, and stairs. In some embodiments, the rider can modify their rider profile if they feel that it is inaccurate. Presenting the rider profile to the rider can inform the rider why a route is presented to the rider. For example, a route can be presented and, if the rider inquires, the rider can be presented with the rider profile and explanation as to why that route was selected.

As there might be a limited amount of data for an individual rider, the rider profile can be based on data for similar riders, such as riders of the same demographics. This can be accomplished by assigning a default profile to a rider based on a data set of other similar riders. As more data for the individual rider is obtained, the default profile can be modified. The modified rider profile or the differences between the rider profile and a population profile can be stored on a server.

A rider might believe they have certain preferences but exhibit other preferences. For example, the rider might wish they valued their time highly but they actually choose comfort over time. For at least this reason, it might be important to not show the rider profile to the rider. Additionally, the rider profile might be difficult to represent as simple weights or variables. For example, the rider profile can be an artificial neural network with a large number of nodes. Besides the difficulties of presenting the large number of nodes to a rider, determining exactly what those nodes represent may prove difficult.

In some embodiments, the rider profile can express how certain the system is that the profile accurately models the rider's preferences. For example, as it is learning the rider's preferences, the profile can indicate it has a lower confidence score whereas later it can have a higher confidence score. The rider profile can have confidence scores related to individual preferences; i.e., the profile can have confidence scores related to weights for environmental metrics for the rider.

In some embodiments, a rider's preferences may change. For example, the rider may begin avoiding routes with stairs or waiting in the rain. When such a change is detected, the system can prompt the rider as to whether such a change is temporary (e.g., the rider is carrying a large package) or reflect a shift in priorities for the rider. A temporary change in preferences can be ignored or have a lesser effect on the rider's profile. Having a system detect changes in behavior might provide an opportunity for a transportation service to better detect the needs or desires of a rider. For example, if a rider begins avoiding stairs, the transportation service can infer that mobility is recently an issue for the rider and can ensure that a “kneeling” bus services the route for the rider. The system can also notify the driver that there may be mobility concerns for the rider so that the driver can assist the rider.

FIG. 15 illustrates an example computing device 1500 that can be used in accordance with various embodiments. Although a portable computing device (e.g., a smart phone or tablet computer) is shown, it should be understood that any device capable of receiving, processing, and/or conveying electronic data can be used in accordance with various embodiments discussed herein. The devices can include, for example, desktop computers, notebook computers, smart devices, Internet of things (IoT) devices, video gaming consoles or controllers, wearable computers (e.g., smart watches, glasses, or contacts), television set top boxes, and portable media players, among others. In this example, the computing device 1500 has an outer casing 1502 covering the various internal components, and a display screen 1504 such as a touch screen capable of receiving user input during operation of the device. These can be additional display or output components as well, and not all computing devices will include display screens as known in the art. The device can include one or more networking or communication components 1506, such as may include at least one communications subsystem for supporting technologies such as cellular communications, Wi-Fi communications, BLUETOOTH® communications, and so on. There may also be wired ports or connections for connecting via a land line or other physical networking or communications component.

FIG. 16 illustrates an example set of components that can comprise a computing device 1600 such as the device described with respect to FIG. 15, as well as computing devices for other purposes such as application servers and data servers. The illustrated example device includes at least one main processor 1602 for executing instructions stored in physical memory 1604 on the device, such as dynamic random-access memory (DRAM) or flash memory, among other such options. As would be apparent to one of ordinary skill in the art, the device can include many types of memory, data storage, or computer-readable media as well, such as a hard drive or solid state memory functioning as data storage 1606 for the device. Application instructions for execution by the at least one processor 1602 can be stored by the data storage 1606 then loaded into memory 1604 as needed for operation of the device 1600. The processor can also have internal memory in some embodiments for temporarily storing data and instructions for processing. The device can also support removable memory useful for sharing information with other devices. The device will also include one or more power components 1610 for powering the device. The power components can include, for example, a battery compartment for powering the device using a rechargeable battery, an internal power supply, or a port for receiving external power, among other such options.

The computing device may include, or be in communication with, at least one type of display element 1608, such as a touch screen, organic light emitting diode (OLED), or liquid crystal display (LCD). Some devices may include multiple display elements, as may also include LEDs, projectors, and the like. The device can include at least one communication or networking component 1612, as may enable transmission and receipt of various types of data or other electronic communications. The communications may occur over any appropriate type of network, such as the Internet, an intranet, a local area network (LAN), a 5G or other cellular network, or a Wi-Fi network, or can utilize transmission protocols such as BLUETOOTH® or NFC, among others. The device can include at least one additional input device 1614 capable of receiving input from a user or other source. This input device can include, for example, a button, dial, slider, touch pad, wheel, joystick, keyboard, mouse, trackball, camera, microphone, keypad, or other such device or component. Various devices can also be connected by wireless or other such links as well in some embodiments. In some embodiments, a device might be controlled through a combination of visual and audio commands, or gestures, such that a user can control the device without having to be in contact with the device or a physical input mechanism.

Much of the functionality utilized with various embodiments will be operated in a computing environment that may be operated by, or on behalf of, a service provider or entity, such as a rideshare provider or other such enterprise. There may be dedicated computing resources, or resources allocated as part of a multi-tenant or cloud environment. The resources can utilize any of a number of operating systems and applications, and can include a number of workstations or servers Various embodiments utilize at least one conventional network for supporting communications using any of a variety of commercially-available protocols, such as TCP/IP or FTP, among others. As mentioned, example networks include for example, a local area network, a wide-area network, a virtual private network, the Internet, an intranet, and various combinations thereof. The servers used to host an offering such as a ridesharing service can be configured to execute programs or scripts in response requests from user devices, such as by executing one or more applications that may be implemented as one or more scripts or programs written in any appropriate programming language. The server(s) may also include one or more database servers for serving data requests and performing other such operations. The environment can also include any of a variety of data stores and other memory and storage media as discussed above. Where a system includes computerized devices, each such device can include hardware elements that may be electrically coupled via a bus or other such mechanism. Example elements include, as discussed previously, at least one central processing unit (CPU), and one or more storage devices, such as disk drives, optical storage devices and solid-state storage devices such as random access memory (RAM) or read-only memory (ROM), as well as removable media devices, memory cards, flash cards, etc. Such devices can also include or utilize one or more computer-readable storage media for storing instructions executable by at least one processor of the devices. An example device may also include a number of software applications, modules, services, or other elements located in memory, including an operating system and various application programs. It should be appreciated that alternate embodiments may have numerous variations from that described above.

Various types of non-transitory computer-readable storage media can be used for various purposes as discussed and suggested herein. This includes, for example, storing instructions or code that can be executed by at least one processor for causing the system to perform various operations. The media can correspond to any of various types of media, including volatile and non-volatile memory that may be removable in some implementations. The media can store various computer readable instructions, data structures, program modules, and other data or content. Types of media include, for example, RAM, DRAM, ROM, EEPROM, flash memory, solid state memory, and other memory technology. Other types of storage media can be used as well, as may include optical (e.g., Blu-ray or digital versatile disk (DVD)) storage or magnetic storage (e.g., hard drives or magnetic tape), among other such options. Based on the disclosure and teachings provided herein, a person of ordinary skill in the art will appreciate other ways and/or methods to implement the various embodiments.

The specification and drawings are to be regarded in an illustrative sense, rather than a restrictive sense. It will, however, be evident that various modifications and changes may be made thereunto without departing from the broader spirit and scope of the various embodiments as set forth in the claims.

What is claimed is:

1. A computer-implemented method, comprising:
obtaining a trip request;
determining a potential routing solution for the trip request;
determining an environmental metric for the potential routing solution; and
evaluating the potential routing solution based on the environmental metric.

2. The computer-implemented method of claim 1, further comprising:
determining a weight for the environmental metric, wherein the step of evaluating the potential routing solution based on the environmental metric is performed using the weight for the environmental metric.

3. The computer-implemented method of claim 2, wherein determining a weight for the environmental metric comprises:
obtaining historical route data for a plurality of historical routes;
determining that the environmental metric is associated with at least one of plurality of historical routes;
determine a rider response to the plurality of historical routes; and
calculate a relationship between the environmental metric and the rider response, wherein the weight is based on the relationship.

4. The computer-implemented method of claim 3, wherein the rider response is the rider taking the respective historical route at a later time.

5. The computer-implemented method of claim 1, wherein determining the environmental metric for the potential routing solution is based on a metric of the routing solution, a time period of the potential routing solution, and an expected public event.

6. The computer-implemented method of claim 1, further comprising:
modifying the potential routing solution based on the environmental metric.

7. The computer-implemented method of claim 1, wherein determining the environmental metric comprises:
determining that the potential routing solution includes a waiting segment, a waiting time of day, and waiting location, wherein the waiting location is associated with an amount of shelter;
determining a predicted weather metric for the waiting time of day and the waiting location; and
determining an amount of climate exposure based on the predicted weather metric and the amount of shelter.

8. The computer-implemented method of claim 1, wherein the at least one environmental metric includes at least one of an accessibility metric, a security metric, or a predicted weather metric.

9. The computer-implemented method of claim 1, further comprising:
determining, based on the at least one environmental metric, an expected demand for the respective potential routing solution.

10. The computer-implemented method of claim 9, wherein the at least one environmental metric relates to an occurrence of a public event.

11. The computer-implemented method of claim 1, wherein the trip request is a simulated trip request for a future time period.

12. The computer-implemented method of claim 1, wherein obtaining a trip request includes receiving the trip request, the trip request being for future transport of a passenger.

13. The computer-implemented method of claim 14, further comprising:
determining a preference related to the environmental metric for the passenger; and
wherein evaluating the potential routing solution is further based on the preference.

14. A system, comprising:
at least one processor; and
memory including instructions that, when executed by the at least one processor, cause the system to:
obtain historical route data for a plurality of historical routes;
determine one or more environmental metrics for the plurality of historical routes;
determine a rider response to the plurality of historical routes;
determine a weight for the one or more environmental metrics based on the rider response;
obtain a potential routing solution having at least one of the one or more environmental metrics; and
evaluate the potential routing solution based on the weight for at least one of the one or more environmental metrics.

15. The system of claim 14, wherein at least one of the one or more environmental metrics includes a predicted weather metric and wherein the instructions when executed further cause the system to:
determine that the potential routing solution includes a waiting segment, a waiting time of day, and waiting location, wherein the waiting location is associated with an amount of shelter; and
determine an amount of climate exposure based on the predicted weather metric and the amount of shelter.

16. The system of claim 15, wherein the instructions when executed further cause the system to:
determine, based on the at least one of the one or more environmental metrics, an expected demand for the potential routing solution.

17. The system of claim 14, wherein the at least one of the one or more environmental metric includes at least one of an accessibility metric or a security metric.

18. A non-transitory computer-readable storage medium including instructions that, when executed by at least one processor of a computing device, cause the at least one processor to:
obtain historical route data for a plurality of historical routes;
determine one or more environmental metrics for the plurality of historical routes;
determine a rider response to the plurality of historical routes;
determine a weight for the one or more environmental metrics based on the rider response;
obtain a potential routing solution having at least one of the one or more environmental metrics; and
evaluate the potential routing solution based on the weight for at least one of the one or more environmental metrics.

19. The non-transitory computer-readable storage medium of claim 18, wherein at least one of the one or more environmental metrics includes a predicted weather metric, and wherein the instructions when executed further cause the at least one processor to:
determine that the potential routing solution includes a waiting segment, a waiting time of day, and waiting location, wherein the waiting location is associated with an amount of shelter; and
determine an amount of climate exposure based on the predicted weather metric and the amount of shelter.

20. The non-transitory computer-readable storage medium of claim 18, wherein the instructions when executed further cause the at least one processor to determine, based on the at least one of the one or more environmental metrics, an expected demand for the potential routing solution.
